(19) United States
(12) Patent Application Publication
(10) Pub. No.: US 2006/0281664 A1
(43) Pub. Date: Dec. 14, 2006

(54) Dryer added article for lint or hair repulsion on fabric

(76) Inventors: Janese Christine O'Brien Stickney, Wyoming, OH (US); Johannson Jimmy Tee JR., West Chester, OH (US); Gabrielle Holly Detzel, Cincinnati, OH (US); Michel Robert Skibinski, Loveland, OH (US); Jennifer Lee Oole, Milford, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/410,673

(22) Filed: Apr. 25, 2006

Related U.S. Application Data
(60) Provisional application No. 60/674,790, filed on Apr. 26, 2005.

(51) Int. Cl. C11D 3/00

(52) U.S. Cl. 510/515

(57) ABSTRACT

Dryer added fabric softening articles are useful for the prevention of lint or hair on fabric.

### CROSS REFERENCE TO RELATED APPLICATION

This application claims priority to U.S. Provisional Patent Application Ser. No. 60/674,790 filed Apr. 26, 2005, the disclosure of which is incorporated by reference herein.

### FIELD OF THE INVENTION

The present invention relates to the use of a dryer-added article for preventing the collection of lint or hair on fabric.

### BACKGROUND OF THE INVENTION

Automatic clothing dryers are well known and are a convenient way of drying laundry. A potential problem with the use of dryers is the collection of lint and/or hair on clothing during the drying process. When laundry comes out of a dryer with lint or hair, often the clothing will be washed again to remove the lint or hair thereby resulting in wasted time and effort.

Another potential problem is the collection of lint and/or hair on clothing during in-wear use of the clothing. This is particularly true for those with pets that shed hair (e.g., dog or cat hair). Typical methods of removing this lint or hair includes the use of a lint roller. However, the use of lint rollers may be time consuming and expensive.

Dryer added fabric softening articles that soften clothing are also well known. However, there is a need for a dryer added article to prevent hair and/or lint build up on clothing during the drying process and/or in-wear use of the clothing.

Therefore, there is a need to prevent the collection of lint and/or hair on clothing during the drying processes of laundering and/or in-wear use of the clothing. There is also a need for a consumer to readily identify an article that addresses this need amongst the myriad of laundry products available in the market place.

### SUMMARY OF THE INVENTION

The present invention attempts to address this need based on the discovery that the use of the dryer-added fabric softening articles may prevent lint and hair from collecting on clothing during the drying process (in an automatic dryer) or in-wear; provided sufficient fabric softening active is administered to the fabric.

One aspect of the invention provides for a method of preventing lint or hair on fabric comprising the step of dosing a dryer added fabric softening article in an automatic clothing dryer, wherein the article comprises sufficient fabric softening active to deliver from about 0.04 g to about 0.4 g of the fabric softening active per 1 kg of dry fabric, during a conventional domestic drying load of laundry.

Another aspect of the invention provides a kit comprising: (a) a dryer added fabric softening article; (b) an instruction instructing the use of the article to prevent lint or hair on fabric; wherein the article comprises sufficient fabric softening active to deliver from about 0.04 g to about 0.4 g of the fabric softening active per 1 kg of dry fabric, during a conventional domestic drying load of laundry.

### DETAILED DESCRIPTION OF THE INVENTION

Definitions

“Dryer-added fabric softening article” is used herein in the broadest sense to include any article that is used in an automatic clothes dryer that comprises a fabric softening active and that imparts a fabric softening benefit to clothing. In one embodiment, the dryer-added fabric softening article is a dryer sheet such as those sold under the trademark of BOUNCE, SNUGGLE, and KIRKLAND or KIRKLAND SIGNATURE. Dryer sheets containing fabric softener actives are described by U.S. Pat. No. 3,442,692; U.S. Pat. No. 3,686,025; U.S. Pat. No. 4,834,895; U.S. Pat. No. 5,041,230; U.S. Pat. No. 5,145,595; U.S. Pat. No. 5,470,492; U.S. Pat. No. 5,476,599; and U.S. Pat. No. 5,883,069. In a second embodiment, the dryer-added fabric softening article is a fabric softening bar as described by U.S. Pat. Pub. 2003/0195130 A1. In a third embodiment, the dryer-added fabric softening article is a fabric softening liquid dispensed into the dryer through a device which can be mounted either inside or outside the dryer itself such as those articles described in U.S. Pat. Pub. No. 2004/0025368 A1; U.S. Pat. Pub. No. 2004/0143994 A1; U.S. Pat. Pub. No. 2004/0134090 A; U.S. Pat. Pub. No. 2004/0123489 A1; U.S. Pat. Pub. No. 2004/0123490 A1.

The term “fabric softening active” includes an active that is suitable for use in an automatic clothing dryer or an automatic laundry washing machine and that imparts a fabric softening benefit to laundry. In one embodiment, the fabric softening active is a cationic nitrogen-containing compound such as quaternary ammonium compound having one or two straight-chain organic groups of at least 8 carbon atoms; preferably one or two such groups of from 12 to 22 carbon atoms and, alternatively ester and/or amide linked. Specific non-limiting examples of softener actives include the following: Di Tallow, Di Methyl Ammonium Methyl Sulfate, N,N-di(oleyi-oxy-ethyl)-N,N-dimethyl ammonium chloride, ,N,N-di(canolyl-oxy-ethyl)-N,N-dimethyl ammonium chloride, N,N-di(oleyl-oxy-ethyl)-N-methyl, N-(2-hydroxyethyl) ammonium methyl sulfate, N,N-di(canolyl-oxy-ethyl)-N-methyl, N-(2-hydroxyethyl) ammonium methyl sulfate-, N,N-di(oleylamidoethyl)-N-methyl, N-(2-hydroxyethyl) ammonium methyl sulfate-, N,N-di(2-oleyloxy oxo-ethyl)-N,N-dimethyl ammonium chloride, N,N-di(2-canolyloxy oxo-ethyl)-N,N-dimethyl ammonium chloride-, N,N-di(2-oleyloxyethylcarbonyloxyethyl)-N,N-dimethyl ammonium chloride, N,N-di(2-canolyloxyethylcarbonyloxyethyl)-N,N-dimethyl ammonium chloride; N-(2-oleyloxy ethyl)-N-(2-oleyloxy oxo-ethyl)-N,N-dimethyl ammonium chloride; N-(2-canolyloxy ethyl)-N-(2-canolyloxy oxo-ethyl)-N,N-dimethyl ammonium chloride, N,N,N-tri(oleyl-oxy-ethyl)-N-methyl ammonium chloride, N,N,N-tri(canolyi-oxy-ethyl)-N-methyl ammonium chloride-, N-(2-oleyloxy oxoethyl)-N-(oleyl)-N,N-dimethyl ammonium chloride, N-(2-canolyloxy oxoethyl)-N-(canolyl)-N,N-dimethyl ammonium chloride, 1,2-dioleyloxy N,N,N-trimethylammoniopropane chloride; and 5,2-dicanolyloxy N,N,N-trimethylammoniopropane chloride, and mixtures of the above actives. In one embodiment, the fabric softening active is N,N-di(tallowyl-oxy-ethyl)-N-methyl, N-(2-hydroxyethyl) ammonium methyl sulfate.

In one embodiment, the “fabric softening active” includes ingredients such as a nonionic fabric softener material. Suitable nonionic fabric softeners are polyoxyalkylene glycols, higher fatty alcohol esters of polyoxyalkylene glycols, higher fatty alcohol esters of polyoxyalkylene glycols, ethoxylates of long chained alcohols of from 8 to 30 carbon atoms such as the ethoxylates of coconut, palm, tallow alcohols or hydrogenated alcohols with 4 to 40 moles of ethylene oxide, and alkanolamides. The fabric softening active may further comprise (with or without a non-ionic fabric softener) fatty acids, ethoxylated fatty acids, and combinations thereof. Preferred fatty acids are those wherein the long chain is unsubstituted or substituted alkyl or alkenyl group of from about 8 to 30 carbon atoms. Examples of specific fatty acids are lauric, palmitic, stearic, oleic, and/or combinations thereof. The term fabric softening active may include other ingredients such as those described in U.S. Pat. No. 5,476,599 at column 6, line 6 to column 9, line 63; and U.S. Pat. No. 5,578,234 at column 2, line 33 to column 11, line 24. In one embodiment, the fabric softening article is a nonwoven sheet comprising a coat mix of about 1 g to about 3 g, alternatively from about 1.5 g to about 2 g; wherein the coat mix comprises about 30% to about 50%, alternatively from about 35% to about 45% of a fabric softening active such as, but not limited to, di-(tallowoyloxyethyl)-N,N-methylhydroxyethylammonium methyl sulfate, by weight of the coat mix. As used herein the term “coat mix” is defined as the compositional chemistry which is deposited onto the surface of the substrate support (e.g., non-woven sheet).

The coat mix may also comprise from about 10% to about 30%, alternatively from about 15% to about 25% of an ethoxylated nonionic by weight of the coat mix. The coat mix may also further comprise from about 5% to about 15% of a fatty acid, alternatively a C15 to C19 fatty acid, by weight of the coat mix. In this embodiment, the nonwoven sheet may comprise an area of from about 15 cm×25 cm to about 18 cm×20 cm. The nonwoven sheet may weigh from about 0.5 g to about 0.8 g. The total weight of the fabric softening article may comprise from about 2 g to about 3 g (i.e., the nonwoven sheet and coat mix).

In another embodiment, the fabric softening article is a nonwoven sheet comprising a coat mix of about 1 g to about 3 g, alternatively from about 1.5 g to about 2 g; wherein the coat mix comprises of a mixture of C10/C12/C14 alkyl ethoxylate with 12 moles EO and C14, C16, C18 fatty acid. In this embodiment, the nonwoven sheet may comprise an area of from about 15 cm×25 cm to about 18 cm×20 cm. The nonwoven sheet may weigh from about 0.5 g to about 0.8 g. The total weight of the fabric softening article may comprise from about 2 g to about 3 g (i.e., the nonwoven sheet and coat mix).

The terms “prevent lint” and “prevent hair” are used herein the broadest sense. The term “prevent” may include the prevention, repulsion, removal, shielding, mitigation, or combinations thereof. For purposes of clarification, the term “prevent” does not necessarily mean that no lint and/or hair is on clothing, rather that there is less lint and/or hair on clothing on a given unit area on clothing treated with an article of the present invention as compared to non-treated clothing. In one embodiment, the term “prevent” means there is about less than 95%, alternatively less than about any one of the following percentages: 90%, 85%, 80%, 70%, 60%, 50%, 40%, 30%, 20%, 10%, or 5% ; of lint and/or hair, by visual inspection, over the total area of the fabric, or alternatively, over any given area or total area of fabric treated with an article of the present invention, as compared to fabric that was not treated with an article of the present invention. In one embodiment, the viewing area is about 63 cm² on each article of fabric.

In turn, the term “lint” is also used herein the broadest sense. In one embodiment, lint is chosen from lint, fuzz, prill, prill fibers, fuzzy, fuzzies, towel fuzzies, paper dust or lint, or combinations thereof.

The term “hair” may include human hair, pet hair, dog hair, cat hair, or a combinations thereof.

Preventing Lint and/or Hair on Clothing:

One aspect of the invention provides for a method of using a dryer added article comprising a fabric softening active to prevent lint and/or hair collecting on clothing. In one embodiment, lint and/or hair is prevented from being collected on clothes during the drying processes in an automatic clothes dryer. In another embodiment, the lint and/or hair is prevented from being collected on clothes during in-wear use.

One aspect of the invention is based upon the surprising discovery that there must be a sufficient fabric softening active administered from the dryer-added article to clothes during the drying process to achieve the lint and/or hair prevention benefit. Specifically, from about 0.04 g to about 0.4 g, alternatively from about 0.17 g to about 1.7 g, of a fabric softening active per 1 kg of dry fabric is administered during the drying process to achieve this benefit. A typical consumer load of dry fabric is about 2.7 kg. A suitable dryer is a KENMORE Heavy Duty 90 Series machine, model no. 66952691. Suitable drying conditions for dispensing the active onto clothing are “high/cotton heat” for 40-50 minutes. A suitable method for determining the amount of fabric softening active dispensed on clothing is to extract fabric softening active(s) from treated fabrics using an appropriate solvent extraction system and then analyze the extract using the appropriate analytical technique, examples of which could include, but are not limited to, titration or liquid chromatography with mass spectroscopy.

In one embodiment, a single use dryer sheet comprises from about 30% to about 60% of fabric softening active by weight of the total surface coat mix.

Container

Another aspect of the invention provides for a container. A suitable container for use in the present invention is any article can be used to contain a dryer added article (e.g., a dryer sheet). Containers may include a box. Containers may have a variety of volumes permitting storage, by way of example, from a single dose to over 120 doses. Containers are typically made from any material including paper or plastic.

Educational Elements.

It is important to effectively communicate the fabric care benefit to the consumer. Educational elements can provide the consumer with sufficient information to quickly understand the fabric care benefit of lint and/or hair prevention on clothing thereby facilitating the consumer to make an informed decision about the article of the present invention.

In one aspect of the invention, a fabric care article of the present invention comprises at least one, alternatively two, alternatively three, alternatively four, alternatively five, educational elements.

A. Visual Descriptor

One example of an educational element is a visual descriptor. The term “visual descriptor” is used herein in the broadest sense to include any illustration, painting, photograph, drawing, or picture that visually describes the lint and/or hair prevention benefit described herein. Non-limiting examples of a visual descriptor include: a magnet; lightening bolt; water beading up on an impenetrable surface, such as water beading up on a waxed car; lint brush; a shield; adhesive tape; surfaces, ideally fabrics, that have lint and/or hair on them; a side-by-side demonstration showing two or more surfaces, where one surface was treated with a fabric softening article of the present invention and a second surface treated a fabric softening article outside of one of the present invention, or a second surface without having been treated with a fabric softening article, and of said surfaces having varying amounts of lint/hair on of the surface; arrows or wavely lines emminating from a fabric item or product logo. In one embodiment, the visual descriptor may also comprise tactile senor elements such as hair and/or lint.

B. Narrative Descriptor.

Another example of an education element is a “narrative descriptor. A “narrative descriptor” is used in the broadest sense to include a narrative that describes (either in writing or orally) the lint and/or hair prevention benefit described herein. In one embodiment, the narrative scent descriptor comprises at least one word, alternatively 2, 3, 4, 5, 6, 7, 8, 9, or 10, or more, words. In another embodiment, the narrative descriptor comprises at least one sentence. In another embodiment, the narrative scent descriptor comprises at least two sentences. A non-limiting example of a narrative descriptor includes: prevents lint and hair; helps prevent lint and hair; repels lint and hair; and helps repel lint and hair. In one embodiment, the narrative descriptor describes the percentage reduction of lint or hair achieved with the use of the fabric softening product of the present invention. The percentage reduction of lint and/or hair may be the same percentages as previously described.

Methods of Disseminating Educational Elements

A. Label

A label provides a convenient point-of-purchase site for educational elements. The term “label” is used herein in the broadest sense to include the tangible medium that educational elements are expressed including, by way of example, the placing of educational element directly on to the packaging for the dryer-added fabric softening article. In one embodiment, the educational element(s) are printed directly on the packaging. In another embodiment, the label is “shrink wrapped” on the packaging. In yet another embodiment, the label is adhered to the container by an adhesive.

B. Media

In one embodiment, educational elements are disseminated in electronic or print media. Electronic media encompasses internet, television, radio or any media broadcast through electronic means. Printed media encompasses all forms of visual or sensory media not transmitted via electronic means (e.g. magazines, billboards, store displays, kiosks, 3-D displays, etc.).

C. On the Fabric Softening Article Itself

In one embodiment, educational elements can be found directly on the fabric softening article itself. This embodiment encompasses printing onto dryer sheets, casting elements into a bar, etc.

Kits and Instructions.

Kits comprising a dryer-added fabric softening article of the present invention and instructions regarding the use of the article for the preventing lint and/or hair are also provided. The instructions may be on the packaging or on the article itself or in a separate unit contained within the package such as a leaflet or insert.

Kits comprising a dryer-added fabric softening article of the present invention and other articles which provide a similar benefit are also provided. Examples include a lint brush, static elimination sprays and wipes, and pet grooming supplies.

### EXAMPLE

The following example provides a method of assessing in-wear hair or lint prevention on fabric.

The following 16 garments comprise one conventional domestic drying laundry load for use in-wear lint and hair testing: 2-50/50 p/c jersey polo shirts; 1-40/60 p/c printcloth shirt; 2-65/35 p/c broadcloth shirts; 1-65/35 p/c/printcloth shirt; 1-65/35 p/c oxford shirt; 1-65/35 p/c twill trouser; 1-100% polyester blouse; 1-100% polyester trouser; 4-80/20 acrylic/nylon sock; and 2-100% nylon slips.

Prior to testing, garments are stripped to remove any mill finishes and to ensure that each treatment truly represents only an assessment of the dryer added article intended, with the assessment not being biased from carryover from previous treatments. Prior to each test, the laundry load is washed with liquid TIDE detergent, dosed according to the manufacturer's instructions, using 140° F. water temperature, 12 minutes washing, followed by two clear water (140° F.) rinses to remove suds. This wash process is again repeated according the procedure previously described and then followed by yet again four wash and eight rinse cycles as above, but without any laundry detergent added. A rectangle of dimensions 2^{7/16} inches (6.2 cm) by 4 inches (10.2 cm) is drawn onto each of the garments in the load using a non-washable marker. This creates a viewing area of about 63.2 cm². The conventional domestic drying laundry load is now prepared for the lint and/or hair prevention test method as herein follows.

The lint and/or hair test method begins by washing and drying a convention domestic drying load. The load is washed in a washing machine from KENMORE with the following settings: a wash cycle setting at single cycle on a “normal” cycle; a 17 gallon fill; a 12 minute wash; and an 11 minute rinse cycle. The water that is used in the washing machine has a hardness of 6-8 gpg, with the water having a temperature of 90° F. for the wash and 60° F. for the rinse. The laundry detergent used for the wash is liquid TIDE free dosed in accordance to the manufacturer's instructions. After the bundle is washed, the bundle is dried in a dryer from KENMORE for 50 minutes on a “regular” cycle. The experimental group is dried with one dryer sheet of BOUNCE Outdoor Fresh Scent in accordance with the manufacturer's instructions. The control group is dried without a dryer sheet. After the 50 minutes, the bundle is allowed to sit on the dryer lid for one hour. Thereafter, the bundle is again placed in the dryer and tumbled for an additional 20 seconds but without heat.

The prevention of lint or hair on fabric is determined as follows. An electrically insulated surface, such as a TEFLON coated cookie sheet, comprising a designated area of about 63 cm² is provided with about 0.08 g of a hair mixture from human, cat and dog origin. This same experiment can also be conducted with 3 micrograms of a lint mixture, wherein the lint mixture is comprised of fabric lint obtained from dryer lint screens, paper lint obtained by rubbing toilet paper between the palms vigorously, and/or 100% polyester carpet fibers. This lint mixture can be added to or without the aforementioned hair mixture.

Exposure of any single garment from the bundle is conducted by holding the outstretched view area of the garment stationary 1 to 3 inches from the surface of designated area with hair. It is the viewing area that is ultimately visually graded for hair prevention. Care is taken never to touch the view area directly to the designated area.

Garments treated in this manner are then taken to a grading room for visual evaluation via Panel Scoring Units (PSU). The grading room contains a standard light source and are graded using the PSU scale as follows: 0=There is no difference, 1=I think there is a difference, 2=I know there is a difference, 3=I know there is a big difference, 4=I know there is a huge difference, versus a no-treatment control. Results are provided in Table 1 in view of a no-treatment control.

TABLE 1

| | Sock | | | Printcloth |
|---|---|---|---|---|
| | 80/20 | Pants | Twill Trousers | Shirt |
| | acrylic/nylon | 100% polyester | 65/35 p/c | 40/60 p/c |
| Hair | 4.0 | 4.0 | 4.0 | 2.5 |
| Lint | 4.0 | 4.0 | 4.0 | 4.0 |

Except as otherwise noted, the articles “a,” “an,” and “the” mean “one or more.”

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description of the Invention are, in the relevant part, incorporated herein by reference; the citation of any document is not to be construed as an admission that it its prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of preventing lint or hair on fabric comprising the step of dosing a dryer added fabric softening article in an automatic clothing dryer, wherein the article comprises sufficient fabric softening active to deliver from about 0.04 g to about 0.4 g of the fabric softening active per 1 kg of dry fabric, during a conventional domestic drying load of laundry.

2. The method of claim 1, wherein the preventing of lint or hair results in less than about 50% less the number of lint or hair on the fabric as compared to fabric that is untreated with the fabric softening article under the same conditions.

3. The method of claim 2, wherein the method provides an average about 90% less lint or hair.

4. The method of claim 3, wherein the method provides an average about 95% less lint or hair.

5. The method of claim 4, wherein the article comprises a non-woven sheet.

6. The method of claim 5, wherein the fabric softening active is a quaternary ammonium compound or nonionic fabric softener material.

7. The method of claim 6, wherein the quaternary ammonium compound comprises at least one chosen from the following: N,N-di(tallowyl-oxy-ethyl)-N-methyl, N-(2-hydroxyethyl)ammonium methyl sulfate, Di Tallow, Di Methyl Ammonium Methyl Sulfate.

8. The method of claim 7, wherein the method is a method of preventing lint.

9. The method of claim 7, wherein the method is a method of preventing hair.

10. A kit comprising:
(a) a dryer added fabric softening article;
(b) an instruction instructing the use of the article to prevent lint or hair on fabric;
wherein the article comprises sufficient fabric softening active to deliver from about 0.04 g to about 0.4 g of the fabric softening active per 1 kg of dry fabric, during a conventional domestic drying load of laundry.
